(19) United States
(12) Patent Application Publication
(10) Pub. No.: US 2006/0117925 A9
(43) Pub. Date: Jun. 8, 2006

(54) Rotary trimmer with switchable blades

(76) Inventors: Boris Volfson, Huntington, IN (US); Donald Thomas Shoebridge, Huntington, IN (US); Shanon Tadd Odman, Roann, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 10/820,669

(22) Filed: Apr. 8, 2004

Related U.S. Application Data
(60) Provisional application No. 60/490,163, filed on Jul. 24, 2003.

(51) Int. Cl. B26D 1/18

(52) U.S. Cl. 83/485; 83/614; 83/678

(57) ABSTRACT

The rotary trimmer with switchable blades of the present invention comprises a base with end retainers moveably supporting a rail, and a cutting assembly disposed on the rail. The cutting assembly includes a switching mechanism to switch between different blades by turning a switch knob accessible outside the housing containing the switching mechanism and the blades. The different blades can have different cutting edges such as a straight, patterned, scalloped, pinking, wave, perforating, or zig-zag edge. Turning the switch knob rotates the desired blade into radial position and locates the desired blade axially over a cutting strip. A clutch engages the switching mechanism during cutting to prevent rotation or axial movement of the switching mechanism.

### TECHNICAL FIELD

The technical field of this disclosure is cutting and trimming devices, particularly, a rotary trimmer with switchable blades.

### BACKGROUND OF THE INVENTION

Rotary trimmers are used to cut paper and other sheet materials, such as cardboard, leather, fabric, plastics, and similar materials. Typically, a sharpened circular blade is mounted in a housing and held perpendicular to a cutting board, and the blade rolled across the cutting board to cut the various materials.

Different types of blades can be used for different applications. While a straight cut may be desirable for simply trimming the edge of a sheet of paper, different cuts may be desirable for other applications. A decorative cut with a scalloped or zig-zag edge may be desirable for craft projects, such as scrapbooks. A zig-zag pinking edge may also be desirable when cutting fabric to avoid fraying. A perforated cut can be used to make tear away forms or for decoration. Although many patterns are useful or desirable, each requires a different blade to make the cut.

Current rotary trimmers require that one blade be manually replaced with another blade when a different shape cut is desired. The user must open a housing, dismount the installed blade, mount the new blade, replace the housing, and store the old blade. The user must handle the exposed blade and risk being cut. This risk prevents children from being able to change the cutter and the cutter pattern. Along with the inconvenience of having to physically switch out the blades, there is the need to provide storage for the blades and the risk that the blades may be lost. U.S. Pat. No. 5,322,001 to Boda, issued Jun. 21, 1994, discloses a cutting board assembly for cutting and/or trimming paper sheets using a single rotary blade and including a few interchangeable blades and a recess in the cutting board for storing the various cutting blades.

It would be desirable to have a rotary trimmer with switchable blades that would overcome the above disadvantages.

### SUMMARY OF THE INVENTION

One aspect of the present invention provides a rotary trimmer with switchable blades that provides various cutting blades without the need to manually change out the blades.

Another aspect of the present invention provides a rotary trimmer with switchable blades that avoids handling the blade.

Another aspect of the present invention provides a rotary trimmer with switchable blades that can be used by anyone.

Another aspect of the present invention provides a rotary trimmer with switchable blades that provides internal storage for blades.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 shows a perspective view of a first embodiment of a rotary trimmer with switchable blades made in accordance with the present invention.

FIGS. 2 & 3 show a perspective view and exploded view, respectively, of the switching mechanism of a rotary trimmer with switchable blades of FIG. 1 made in accordance with the present invention.

FIG. 4 shows a detail perspective view of the clutch and pusher of a rotary trimmer with switchable blades of FIG. 1 made in accordance with the present invention.

FIGS. 5 & 6 show a detail view and exploded view, respectively, of the cutters of a rotary trimmer with switchable blades of FIG. 1 made in accordance with the present invention.

FIGS. 7a-9b show detailed views of exemplary embodiments of cutters of a rotary trimmer with switchable blades made in accordance with the present invention.

FIG. 10 shows a perspective view of a second embodiment of a rotary trimmer with switchable blades made in accordance with the present invention.

FIG. 11 shows an exploded perspective view of the rotary trimmer with switchable blades of FIG. 10 made in accordance with the present invention.

FIGS. 12 & 13 show a detail view and exploded view, respectively, of the cutting assembly of a rotary trimmer with switchable blades of FIG. 10 made in accordance with the present invention.

### DESCRIPTION OF THE PRESENTLY PREFERRED EMBODIMENT

The rotary trimmer with switchable blades of the present invention comprises a base with end retainers moveably supporting a rail, and a cutting assembly disposed on the rail. The cutting assembly includes a switching mechanism to switch between different blades by turning a switch knob accessible outside the housing containing the switching mechanism and the blades. The different blades can have different cutting edges such as a straight, patterned, scalloped, pinking, wave, perforating, or zig-zag edge. Turning the switch knob rotates the desired blade into radial position and locates the desired blade axially over a cutting strip. A clutch engages the switching mechanism during cutting to prevent rotation or axial movement of the switching mechanism.

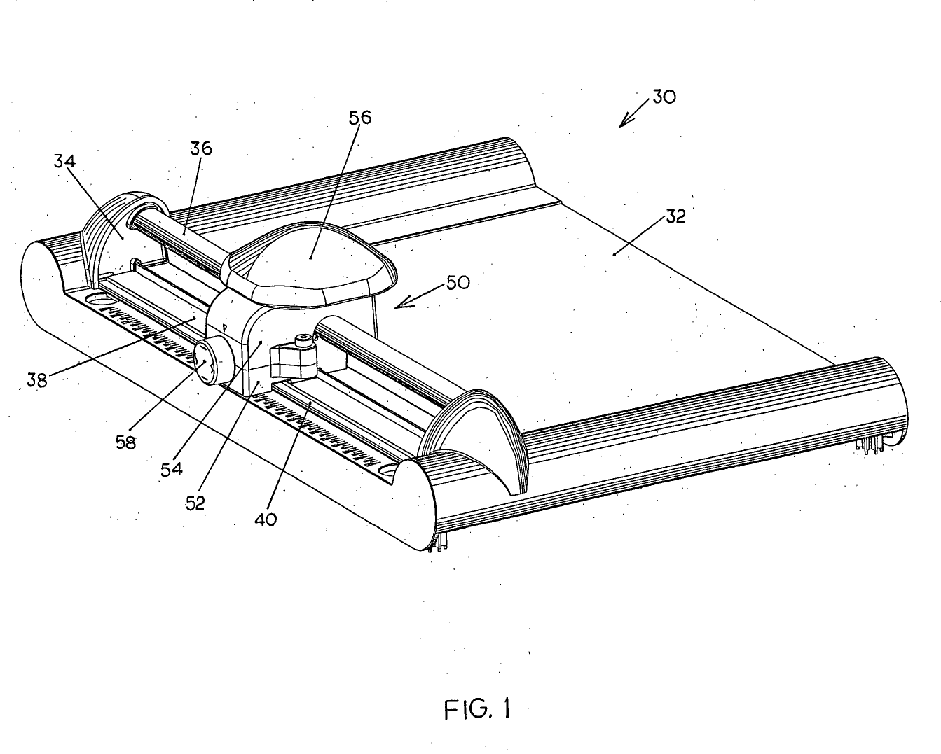

FIG. 1 shows a perspective view of a rotary trimmer with switchable blades made in accordance with the present invention. The rotary trimmer 30 comprises a base 32, end retainers 34 moveably supporting a rail 36, and a cutting assembly 50 disposed on the rail 36. A ruler 38 is disposed on the base 32. A self-healing strip 40, recessed in the base 32, receives the blade during cutting. The cutting assembly 50 comprises a lower housing 52, an upper housing 54, a push knob 56, and a switch knob 58. The switch knob 58 is connected to the switching mechanism (not shown) within the housing and controls the blade selection. Although the switch knob 58 is presented as an example of the means for the user to select the desired blade, those skilled in the art will appreciate that other mechanisms, such as a lever, handle, switch, bar, button, or the like, can be used without departing from the spirit of the invention.

To cut a sheet with the rotary trimmer 30, the desired blade can be selected by turning the switch knob 58 to the desired blade indication. The sheet (not shown) to be cut is positioned on the base 32 below the ruler 38 and rail 36. The cutting assembly 50 is positioned where the cut is to start, the push knob 56 depressed to lock the blade position and to lock the sheet in position by pressing the ruler 38 toward the base 32. The cutting assembly 50 can then be slid along the rail 36 to make the cut and the push knob 56 released at the end of the cut.

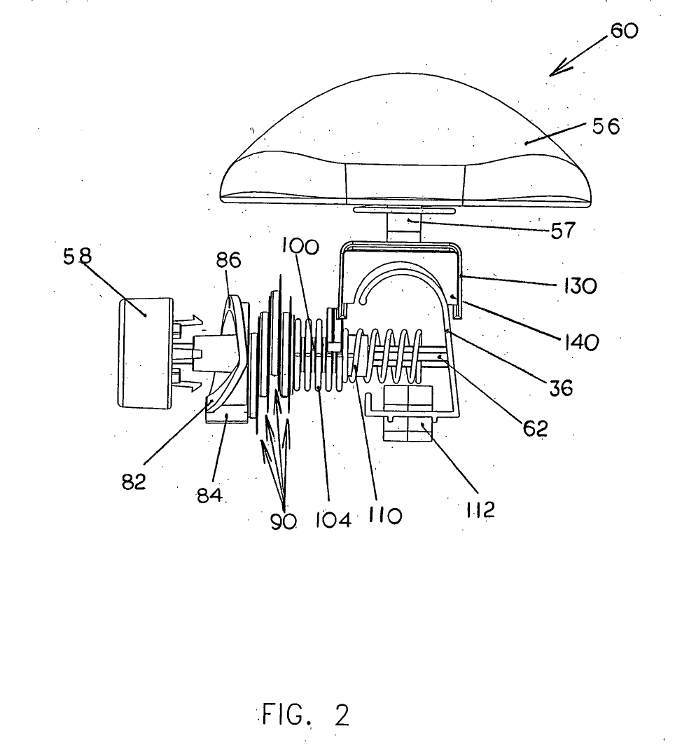

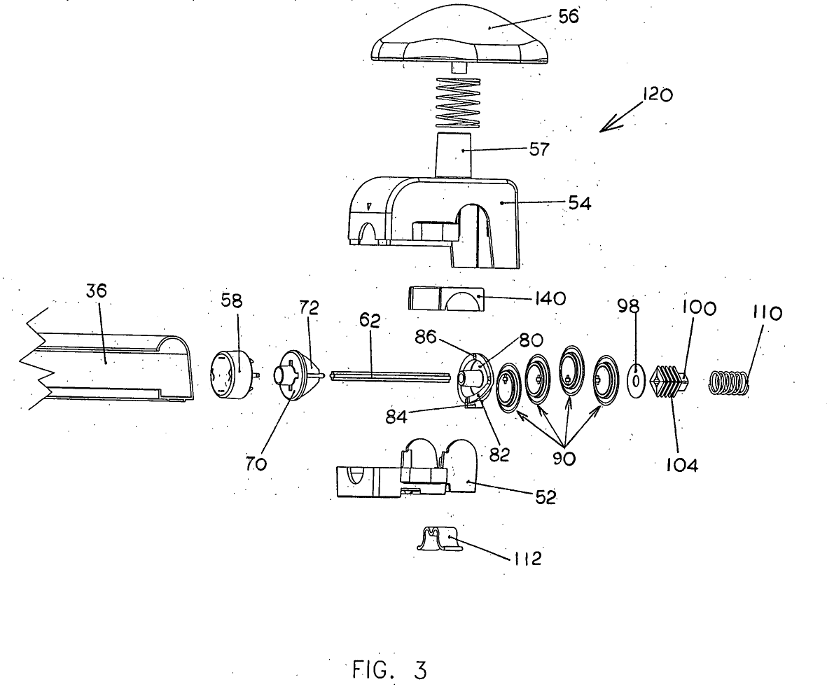

FIGS. 2 & 3 show a perspective view and exploded view, respectively, of the switching mechanism of a rotary trimmer with switchable blades made in accordance with the present invention. The switching mechanism 60 is typically housed within the upper housing 54 and lower housing 52 of the cutting assembly. A shaft 62, of a cruciform profile, supports and operably connects the components of the switching mechanism 60. The switch knob 58 is fixedly connected to the shaft 62 and the cam driver 70. In an alternate embodiment, the switch knob 58 and the cam driver 70 can be a single piece.

A cam 80, blades 90, a washer 98, a pusher 100, and a spring 110 are slidably supported on the shaft 62. The end of the spring 110 away from the pusher 100 contacts a stationary bearing surface in the lower housing 52, so that the spring 110 urges the cam 80, the blades 90, the washer 98, and the pusher 100 toward the switch knob 58.

The cam driver 70 has an extended boss 72, which moves the cam 80 axially through the force of the extended boss 72 along a sloped surface 82 of the cam 80. In turn, the cam 80 moves the desired blade 90 axially into cutting position. The stack of blades 90 and the pusher 100 are urged toward the cam 80 by the spring 110. The cam 80 can include semi-spherical pits 86 in the sloped surface 82 to act as positive stops when the switch knob 58 is at a cutting position for one of the blades 90. As the cam 80 moves the desired blade into axial position, the rotation of the shaft 62 moves the desired blade into radial position.

The shaft 62 passes through a circular opening in the cam 80, so the cam 80 does not rotate when the shaft 62 is turned. Cam rib 84 is slidably disposed in a slot in the lower housing 52 to prevent the cam 80 from rotating while allowing the cam 80 to slide axially on the shaft. The shaft 62 passes through cruciform openings 96 in the blades 90 and pusher 100, so the blades 90 and pusher 100 rotate when the shaft 62 is turned. The cruciform opening 96 can be on the axis for the pusher 100 and off the axis (eccentric) for the blades 90. In one embodiment, the pusher 100 and the spring 110 can be made as a single piece. The pusher 100 has pusher ribs 104 that are used with the clutch 130 to keep the switching mechanism 60 from rotating or shifting axially during cutting.

The switching mechanism 60 is supported at the switch knob 58 in semicircular cutouts in the upper and lower housings where the switch knob 58 passes into the housing and at the rail end by bearing surfaces in the lower housing 52. A traveling spring 112 can be mounted between the rail 36 and the lower housing, and operably connected to the lower housing, to urge the lower housing against the upper portion of the rail. In one embodiment, the traveling spring 112 can be a leaf spring made of plastic, although those skilled in the art will appreciate that many shapes and materials are suitable for the intended use.

A clutch mechanism 120 comprises the push knob 56, a clutch 130, and a pad 140. A push knob stem 57 passes through an opening in the upper housing and engages the clutch 130. The pad 140 slidably supports the clutch 130 on the rail 36. The pad 140 can have a low coefficient of friction with the rail 36 to allow the cutting assembly to easily slide along the rail during cutting. The clutch 130 engages the pusher 100 when the push knob 56 is depressed, to prevent rotation or axial movement of the switching mechanism 60 during cutting.

To use the rotary trimmer, the user turns the switch knob 58 so that the indicia on the switch knob 58 corresponding to the desired cut design or blade lines up with a mark on the housing. The switch knob 58 rotates the cam driver 70, moving the extended boss 72 along the sloped surface 82 of the cam 80 until the extended boss 72 stops in the pit 86, and the selected blade 90 is in the final axial location over the self-healing strip in the base. As the axial movement occurs, the rotation of the switch knob 58 rotates the shaft 62 together with the blades 90, bringing the selected blade 90 into the final radial position at a slot in the lower housing. With the selected blade in position, the user depresses the push knob 56, which moves the clutch 130 to lock the pusher 100 in position. Continued pressure on the push knob 56 moves the rail downward so that the sheet to be cut is held between the ruler and the base and the selected blade engages the sheet. The user slides the cutting assembly along the rail to make the cut as the blade's cutter rotates about its hub, releases the push knob 56 to release the cut sheet, and finishes the cutting operation.

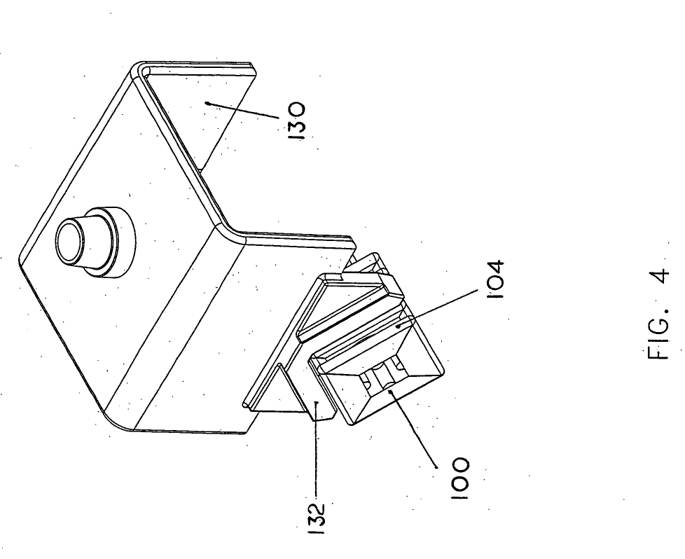

FIG. 4 shows a detail perspective view of the clutch and pusher of a rotary trimmer with switchable blades made in accordance with the present invention. When the push knob is depressed, the clutch 130 positively engages the pusher 100 to prevent rotation and axial movement. When the push knob is in the up position, the clutch 130 and pusher 100 are disengaged and the switching mechanism, including the pusher 100, is free to rotate. The engaging portion 132 of the clutch 130 mates with the flats of the pusher ribs 104 to prevent rotation of the shaft, which passes through a cruciform central opening 102 of the pusher 100. The engaging portion 132 of the clutch 130 can also project into the space between the pusher ribs 104 to axially restrain the pusher 100. When the push knob is in the up position, the clutch 130 is free of the pusher 100, so that the pusher 100 can rotate freely with the shaft 62, or move axially along the shaft. Those skilled in the art will appreciate that a number of mechanisms can accomplish the goal of preventing rotation and axial movement. In one embodiment, the clutch and pusher could be omitted and the rotation of the switch knob restrained to lock the shaft. In another embodiment, the pusher could be omitted and the clutch could engage the shaft directly. In yet another embodiment, the clutch could have a pin that passes through the pusher and/or shaft to lock the position.

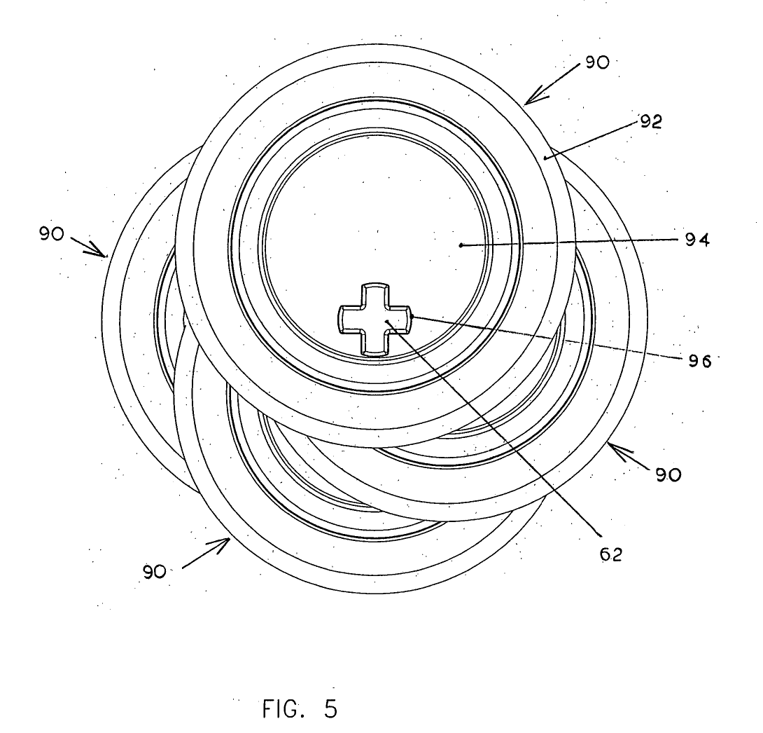

FIGS. 5 & 6 show a detailed view and exploded view, respectively, of the cutters of a rotary trimmer with switchable blades made in accordance with the present invention. The blade 90 comprises a circular cutter 92 disposed about a blade hub 94, the blade hub 94 having the cruciform opening 96, eccentrically positioned for receiving the shaft 62. The blade 90 can have a straight cutting edge as shown, or can have a patterned edge, including but not limited to, a scalloped, pinking, wave, perforating, or zig-zag edge. The blade 90 can cut a sheet completely with a straight cut or a decorative cut, or can leave the sheet intact and cut a perforation or series of decorative holes or designs. The cutter 92 is rotatable about the blade hub 94, so that the cutter 92 can rotate about the blade hub 94 during cutting. In one embodiment, the blade hub 94 can be retained in the cutter 92. In another embodiment, the blade hub 94 can fit loosely in the cutter 92 and the fit maintained by the force of the pusher on the stack of blades.

As shown in FIG. 5, the blades 90 can be mounted on the shaft 62 with each hub rotated by ninety degrees, so that the maximum distance between the shaft 62 and the blade edge points a different direction for each blade. Thus, rotating the shaft by ninety degrees moves a different blade into cutting position. It will be appreciated by those skilled in the art that the number of blades can be more or fewer than the four blades shown as an example, as required to suit a particular application.

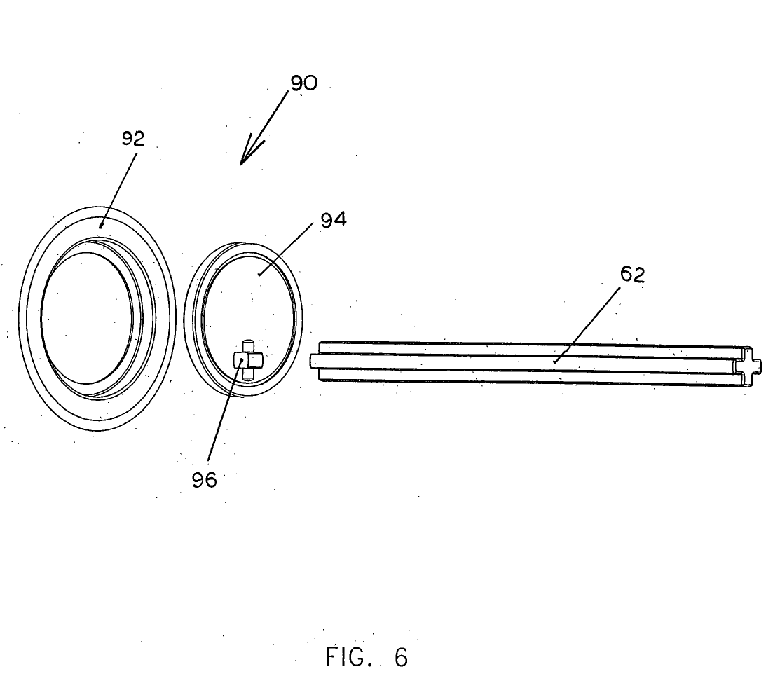

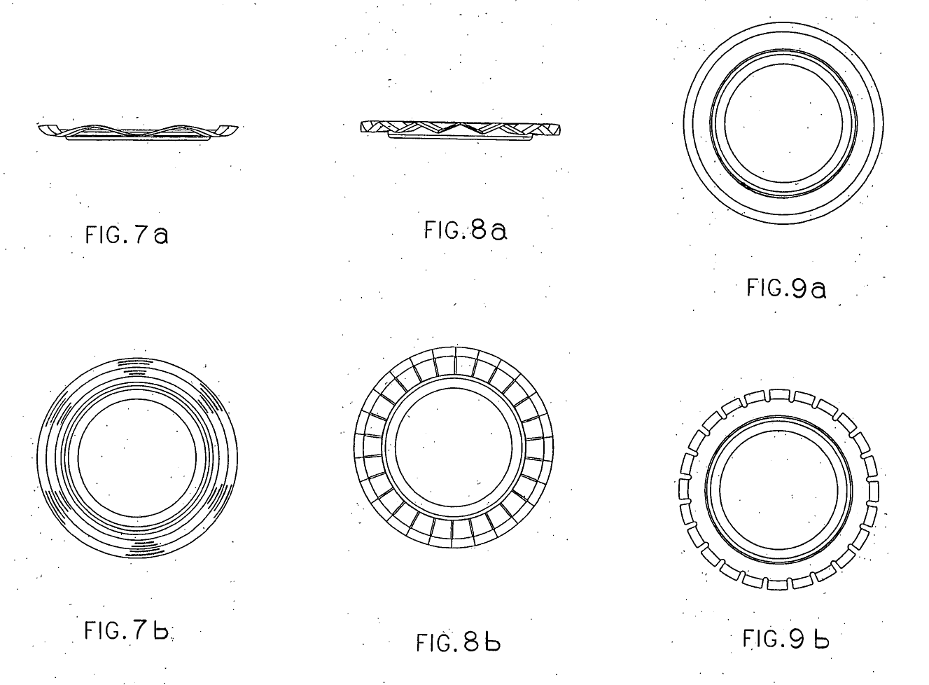

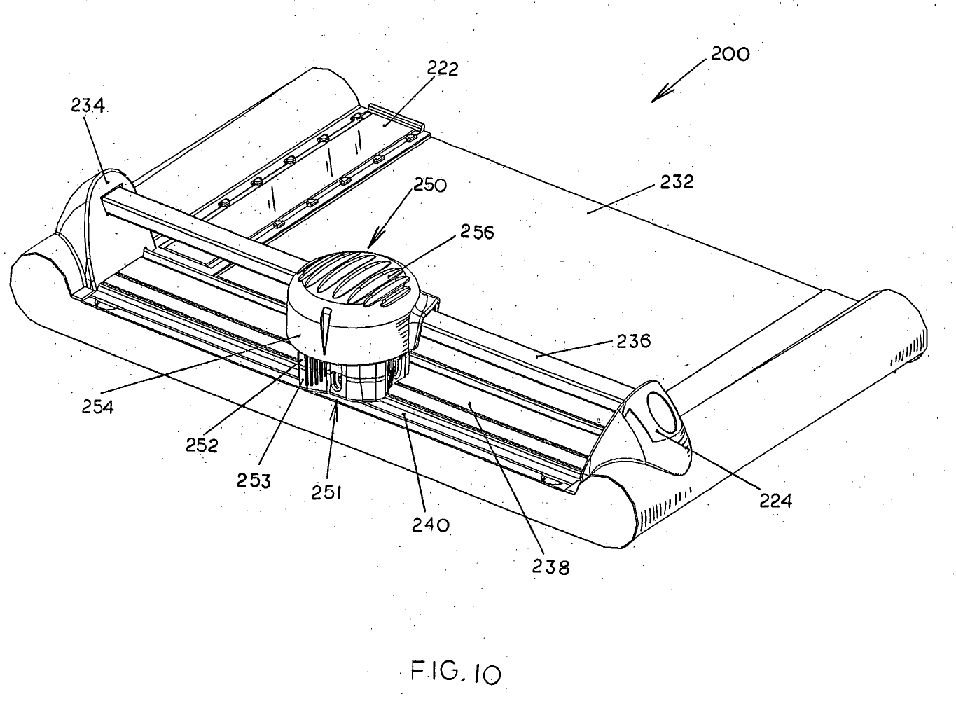

FIGS. 7a-9b show detailed views of exemplary embodiments of cutters of a rotary trimmer with switchable blades made in accordance with the present invention. FIGS. 7a & 7b illustrate a blade for making a scallop-like cut. FIGS. 8a & 8b illustrate a blade for making a pinking cut. FIG. 9a illustrates a simple cutting edge for straight line cutting and FIG. 9b illustrates a blade for making a perforation cut.

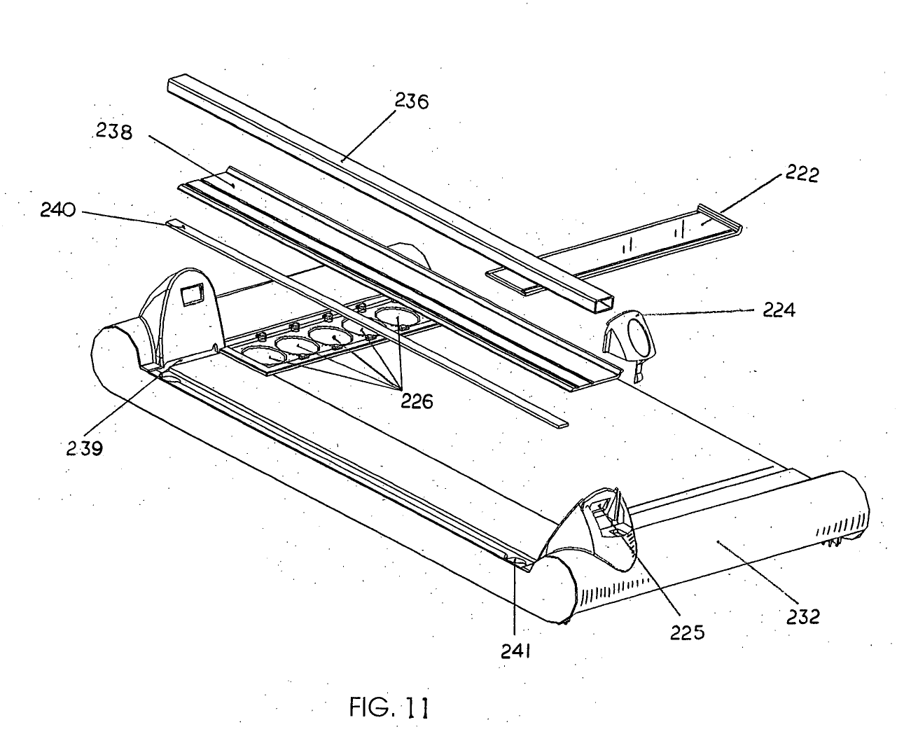

FIGS. 10 to 13 illustrate a second embodiment of a rotary trimmer with switchable blades made in accordance with the present invention. This embodiment may also use the blades illustrated in FIGS. 7a to 9b.

FIGS. 10 & 11 shows a perspective view and an exploded view, respectively, of a second embodiment of a rotary trimmer with switchable blades made in accordance with the present invention. The rotary trimmer 200 comprises a base 232, end retainers 234 moveably supporting a rail 236, and a cutting assembly 250 disposed on the rail 236. The rail 236 is slidably secured in rail openings 239. A self-healing strip 240 recessed in the base 232 receives the blade during cutting. The end retainers 234 may include rail retainers 224. Rail retainers 224 can be opened to allow the rail to be removed so that the cutting assembly 250 may be removed for replacement of the assembly 250 or the blades. A ruler 238 is disposed on the base 232 and may be secured in ruler slots 239. Finger recesses 241 are formed as semispherical pits in the surface of the base 232 for the easy removal of the self-healing strip 241.

The cutting assembly 250 comprises a lower housing 251 having an upper portion 252 and lower portion 253, an upper housing 254, and a push knob portion 256. The lower housing 251 is connected to the switching mechanism (not shown) within the housing and controls the blade selection. The rotation of the lower housing 251 changes the selection of the blade as the blades are rotated about a central axis of the cutting assembly 250.

The rotary trimmer 200 further comprises a spare blade compartment for storing spare cutting blades. The spare blade compartment includes a cover 222, and a plurality of blade compartments 226. The cover 222 may be slidably attached to the trimmer 200 and may be flush with the surface of the base so as not to interfere with the placement of the material to be cut.

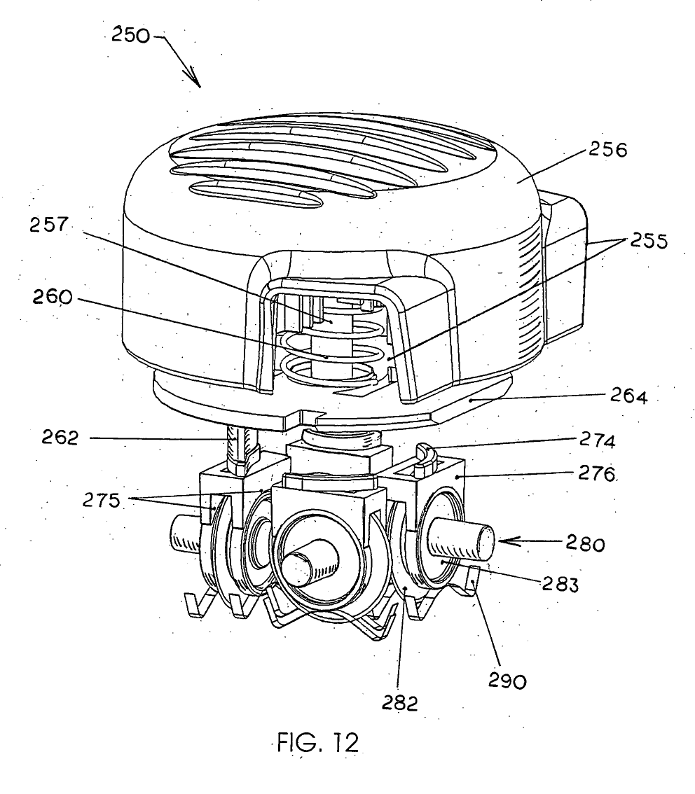

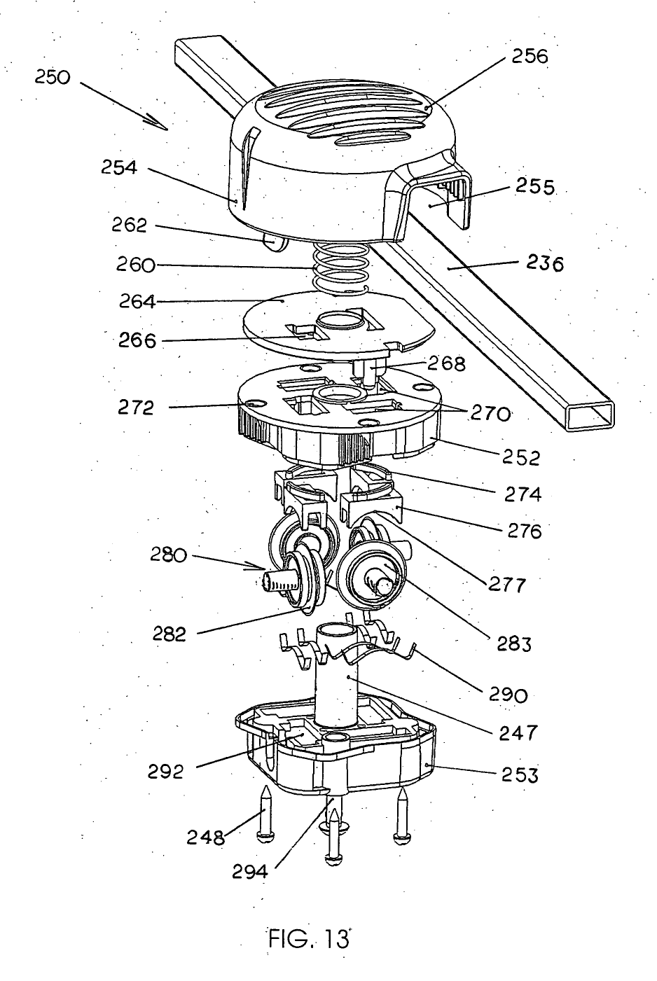

FIGS. 12 & 13 show a detail view and exploded view, respectively, of the cutting assembly 250 of a rotary trimmer 200 with switchable blades of FIG. 10 made in accordance with the present invention. The cutting assembly 250 includes the upper housing 254, the lower housing 251, an indexing plate 264, and cutting blade assemblies 280.

The cutting assembly 250 slides along the rail 236 during operation. The upper housing 254 includes a pair of rail openings 255 that receive the rail 236.

The upper housing includes the push knob portion 256, a threaded centering pin 257, and a spring 260 placed around the centering pin 257. The spring 260 is a compression spring having one end containing an inside surface of the housing 254 and a second end contacting a top surface of the indexing plate 264. The housing 254 further includes a cutting blade activation pin 262. The pin 262 is located on, and extends from, the bottom surface of the knob portion 256 of the housing 254. The pin 262 may be formed integrally with housing 256, or may be formed separately and then securely attached by means well known in the art.

The indexing plate 264 includes an activation pin opening 266 through which the pin 262 reciprocatingly moves in order to activate the cutting blade. The indexing plate 264 further includes an indexing pin 268 for indexing the cutting assembly when the lower housing is rotated when changing the current blade to a different blade contained within the assembly. The indexing plate 264 also includes a central opening through which the centering pin 257 passes for alignment of the various components of the assembly 250.

The lower housing 251 includes an upper portion 252 and a lower portion 253. The upper portion 252 is placed adjacent the indexing plate 264. The upper portion 252 of the housing 251 includes a central opening through which the pin 257 passes. The upper portion 252 also includes a plurality of openings, each opening receives a blade-actuating device 276. The upper portion 252 further includes a plurality of semi-circular pits 272 that receive an end portion of the indexing pin 268.

The blade-actuating device 276 includes a top surface for contacting the pin 262. In one embodiment, the top surface includes a raised portion 274 that contacts the end portion of pin 262. The shape of the raised portion 274 corresponds with the shape of the pin 262. In other embodiments, the blade-actuating device 276 does not include a raised portion 274 but includes a longer pin 262 for contacting and engaging the top surface of the blade-actuating device 276. The blade-actuating device 276, on the underside surface, further includes two spaced apart arches 275. Arches 275 each include a contact surface 277 for contacting a blade assembly 280.

The blade assembly 280 includes a cutting blade 282 and a hub 283 that extends on either side of the blade and forms a surface for contacting the blade-actuating device 276.

The shape of the arch 275 corresponds to the shape of the hub 283 of the blade assembly 280. The dual arch of the blade-actuating device 276 is such that when the surface 277 contacts the hub surface on either side of the blade, the blade is still free to rotate during the material cutting process. The blade-actuating device 276 and the hub 283 may be executed from dissimilar synthetic materials in order to reduce friction.

The lower housing portion 253 defines a plurality of pocket openings 292, each for receiving a single blade assembly. Each of the pockets 292 also receives a pair of leaf springs 290. The leaf springs 290 are positioned within the pocket openings 292 such that, during operation of the cutting assembly, the hub 283 presses down on the leaf spring. Upon release of the knob, the leaf springs moves the blade assembly from a cutting position into a resting position.

The lower housing portion 253 further includes a plurality of openings on the underside of the housing through which an attachment device is inserted in order to secure the upper portion 252 of the lower housing to the lower portion 253 of the lower housing. These attachment devices may take the form of screws 248. Lower housing portion 253 also includes a centering cylinder 247 for receiving the centering pin 257. An attachment device 294 is used to secure the upper housing 254 to the lower housing 251 via the centering pin 257. Those with skill in the art will recognize that there are many other ways of removable securing the upper housing to the lower housing.

In operation, the user selects the appropriate blade by rotating the lower housing 251. Once selected, the user presses down on the knob 256 causing the pin 262 to move through the opening 266 to contact the blade-actuating device 276. The blade-actuating device 276 will then move to contact the hub 283 of the blade assembly 280. Further downward pressure on the knob 256 causes the blade assembly to move from a resting position to a cutting position, the blade moving through an opening in the lower portion of the lower housing 251 and contacting the material to be cut. Sliding the assembly 250 over the rail 236 will cut the intended material. Release of the pressure on the knob will cause the leaf springs to push against the blade assembly to move the blade from a cutting position into the resting position.

It is important to note that FIGS. 1-13 illustrate specific applications and embodiments of the present invention, and is not intended to limit the scope of the present disclosure or claims to that which is presented therein. For example, more or less than four blades could be used. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

A current version of the claims is:

1. A rotary trimmer comprising:
a base;
end retainers, the end retainers attached to the base;
a rail, the rail moveably supported by the end retainers; and
a cutting assembly, the cutting assembly having switchable blades and means for switching the switchable blades.

2. The rotary trimmer of claim 1 further comprising a self-healing strip disposed in the base for receiving the switchable blade while cutting.

3. A switching mechanism for a rotary trimmer comprising:
a shaft;
a cam driver, the cam driver being fixed on the shaft and having an extended boss;
a cam, the cam being slidably supported on the shaft and having a sloped surface, the sloped surface operably connectable to the extended boss;
at least one blade, the blade being slidably supported on the shaft through an eccentric opening; and
a spring, the spring being slidably supported on the shaft and urging the blade towards the cam.

4. The switching mechanism of claim 3 wherein the switching mechanism has a plurality of blades.

5. The switching mechanism of claim 3 wherein the shaft is cruciform and the eccentric opening is cruciform.

6. The switching mechanism of claim 5 wherein the switching mechanism has four blades.

7. The switching mechanism of claim 3 wherein the blade is selected from the group consisting of a straight edged blade, patterned edged blade, scalloped edged blade, pinking edged blade, wave edged blade, perforating edged blade, and zig-zag edged blade.

8. The switching mechanism of claim 3 further comprising:
a pusher, the pusher being slidably supported on the shaft;
and a clutch, the clutch being mateably connectable to the pusher.

9. The switching mechanism of claim 8 wherein the pusher has pusher ribs and the clutch has an engaging portion mateable with the pusher ribs.

10. The switching mechanism of claim 3 wherein the blade comprises a blade hub and a cutter rotatably disposed on the blade hub.

11. The switching mechanism of claim 3 wherein the sloped surface further comprises pits for receiving the extended boss.

12. A switching mechanism for a rotary trimmer comprising:
a shaft;
at least one blade, the blade being slidably supported on the shaft;
means for rotating the shaft; and
means for moving the blade into cutting position responsive to the shaft rotating means.

13. The switching mechanism of claim 12 wherein the switching mechanism further comprises a plurality of blades.

14. The switching mechanism of claim 12 wherein the means for moving the blade further comprises means for moving the blade axially and means for moving the blade eccentrically.

15. The switching mechanism of claim 13 wherein the means for moving the blade further comprises means for urging the blade toward the means for moving the blade axially.

16. The switching mechanism of claim 12 further comprising means for locking the blade in the cutting position.

17. The switching mechanism of claim 16 wherein the means for locking the blade in the cutting position further comprises means for locking the blade axially and means for locking the shaft radially.

18. The switching mechanism of claim 12 wherein the blade further comprises means for cutting and means for supporting the cutting means on the shaft.

19. The switching mechanism of claim 12 wherein the blade further comprises means for perforating and means for supporting the perforating means on the shaft.

20. A switching mechanism for a rotary trimmer comprising:
a shaft, the shaft being cruciform;
a switch knob fixed on the shaft;
a cam driver, the cam driver fixed in relation to the shaft and having an extended boss;
a cam, the cam slidably supported on the shaft and having a sloped surface, the sloped surface contacting the extended boss;
a plurality of blades, the plurality of blades each having a cruciform eccentric opening, the plurality of blades being slidably supported on the shaft through the cruciform eccentric openings;
a pusher, the pusher having a cruciform central opening, being slidably supported on the shaft through the cruciform central opening, and having a plurality of pusher ribs;
a spring, the spring slidably supported on the shaft, the spring urging the pusher and plurality of blades toward the cam;
a push knob; and
a clutch responsive to the push knob, the clutch having an engaging portion mateable with the plurality of pusher ribs.

21. A rotary trimmer, comprising:
a base;
a rail mounted to said base;
a cutting assembly slidably mounted on said rail; and,
a plurality of blades mounted in said cutting assembly, wherein said cutting assembly is rotatable to selectively position a desired one of said blades in an operative position relative to said base.

22. The rotary trimmer of claim 21, wherein said cutting assembly comprises a knob rotatable to controllably position a selected one of said blades in an operative position.

23. The rotary trimmer of claim 22, wherein said knob includes indicia indicating a corresponding selected blade.

24. The rotary trimmer of claim 23, wherein said cutting assembly defines positive stops engagable with said knob to indicate when a blade is in the operative position.

25. The rotary trimmer of claim 22, wherein said cutting assembly is rotatable to at least four positions to selectively position said blades.

26. The rotary trimmer of claim 25, wherein said plurality of blades comprises at least three circular cutting blades.

27. The rotary trimmer of claim 26, wherein said circular cutting blades include at least a straight edge blade, a scalloped edge blade, and a perforating blade.

28. The rotary trimmer of claim 27, wherein said cutting assembly is downwardly movable towards said base to engage the selected blade with one or more sheets of paper arranged on said base.

29. The rotary trimmer of claim 28, wherein said cutting assembly comprises a clutch operative when said cutting assembly is downwardly moved, wherein said clutch prevents the selected blade from moving from the operative position.

30. The rotary trimmer of claim 22, wherein said knob controls a rotatable shaft and wherein said blades are radially positioned around said shaft such that rotation of said shaft controllably positions a selected one of said blades in the operative position.

31. The rotary trimmer of claim 30, wherein said cutting assembly comprises a spring outwardly biasing said knob from said cutting assembly.

32. The rotary trimmer of claim 31, wherein said cutting assembly comprises a pusher disposed between said spring and said blades.

33. A rotary trimmer comprising:
a base;
a rail moveably mounted to said base;
a cutting assembly slidably mounted on said rail; wherein said cutting assembly is rotatable to at least four positions to position a selected one of a plurality of blades in an operative position relative to said base;
said cutting assembly comprising:
a housing;
at least three circular cutting blades mounted in said housing;
a rotatable shaft, wherein said at least three circular cutting blades are radially
positioned around said shaft such that rotation of said shaft controllably positions
a selected one of said blades in said operative position; and,
a knob operable to controllably rotate said shaft.
